(19) United States
(12) Patent Application Publication
(10) Pub. No.: US 2011/0267827 A1
(43) Pub. Date: Nov. 3, 2011

(54) LIGHT CONSUMABLE HOUSING AND CHANGING SYSTEM

(75) Inventor: Bradley Wein, Caulfield North, VIC (AU)

(73) Assignee: Lijesa Developments Pty Ltd, Caulfield North, VIC (AU)

(21) Appl. No.: 13/123,856

(22) PCT Filed: Dec. 1, 2009
(86) PCT No.: PCT/AU2009/001567

§ 371 Date: Jun. 23, 2011

(30) Foreign Application Priority Data
Jan. 21, 2009 (AU) 2009900227

(51) Int. Cl. F21V 15/01

(52) U.S. Cl. 362/368

(57) ABSTRACT

A housing (21) for holding a light consumable (22) or a mounting unit (42) on which the light consumable (22) is mounted. The housing includes at least one opening (23) for receiving the light consumable (22) and allowing transmission of light from the light consumable when mounted in the housing (21). An electrical connection means having first and second parts (29A) and (29B) provide the electric power to the mounted light consumable. A holding means further includes a first part of a magnetic means whereby a second part of the magnetic means mounted on an elongated arm which can be positioned adjacent the first part of the magnetic means and provide magnetic force at the opening so as to withdraw the light consumable or the unit on which the light consumable is mounted from within the housing.

### FIELD OF THE INVENTION

This invention relates to a light consumable housing and changing system and in particular a system to house and allow ready changing of halogen “downlight” light consumables mounted in ceilings but is not limited to such.

The term “a light consumable” throughout this document is to mean the disposable or replaceable portion of a light source due to its inherent limited life or breakage characteristics. It can include a globe only or other light source that is replaced or it can include a number of elements including a globe and a part of the electric supply structure and/or part of the physical mounting that can be replaced at the same time as the globe.

### BACKGROUND TO THE INVENTION

Light fittings are most commonly located in ceilings or high on walls. To change the light consumable a ladder is usually needed. There is inherent risk in using a ladder, the most serious of which is severe injury resulting from a fall from height. Also not every person is capable of climbing a ladder. For those people the light consumable is usually changed by employing a physically capable person to do the job thus increasing the time and potential cost needed to perform what is a common function.

There are some devices on the market that allow a person to change particular light consumables without using a ladder. These devices are generally elongated wands that include a gripping device such as a gripping claw or suction cup. These wands are not designed for and are incapable of changing light consumables that are designed for light fittings that require two hands to change the consumable. These include halogen “downlight” light fittings.

Halogen downlights are most often installed in the ceiling, with only the front planar surface and surround showing. This form of light fitting is very popular in both domestic and commercial premises.

Halogen downlights most often run on low voltage such as 12 Volt or 24 Volt rather than mains supply voltage at 110, 220 or 240 Volts or similar. However some halogen downlights are designed to use the voltage directly from the mains supply.

Where halogen downlights are low voltage, the voltage is stepped down via a transformer which is invariably supplied with the light fitting.

The halogen downlight fitting usually comprises two main parts. The first part, the housing, is fixed to the ceiling. The second part is removable and clips or screws into the housing. The light consumable fits into the removable part and is held in place usually via retaining springs or metal clips.

To replace a light consumable of a standard halogen downlight the following functions need to be performed;
climb the ladder;
remove the removable mounting part of the light fitting;
disconnect the light consumable from the power supply connection;
unclip and remove the light consumable;
insert a new light consumable;
reconnect the power supply connection;
reinsert the removable part of the light fitting into the fixed part of the fitting; and
dismount from the ladder.

Two hands are needed to perform most of the above functions leaving the person changing the light consumable highly vulnerable to falling from the ladder.

Accordingly, it is an object of the present invention to overcome or at least substantially ameliorate one or more of the disadvantages of the prior art and in particular increase the ease of replacement and decrease the risk of injury in replacement of a light consumable.

### SUMMARY OF THE INVENTION

The present invention provides in one form a light consumable housing apparatus including a housing having at least one opening for receiving a light consumable or a mounting unit on which the light consumable is mounted, at least one part of an electrical connection means for connection to an electricity supply of the light consumable when mounted in the housing and a holding means for releasably holding the light consumable or the mounting unit on which the light consumable is mounted to the housing wherein at least one element of the holding means is magnetic.

The housing can include a concave body having a throat for receiving a first part of the electrical connection of the mounted light consumable and forming an electrical connection by abutting engagement to a second part of the electrical connection mounted in the throat with the opening at the larger end allowing emission of light from the light consumable when mounted therein and in use.

The holding means can include a spring means for releasably holding the light consumable or the mounting unit on which the light consumable is mounted in the housing.

The holding means can include at least one element positioned on the inside body of the housing for releasably holding the light consumable or the mounting unit on which the light consumable is mounted in the housing at least partly by magnetic force.

The holding means can include a holding element at the electrical connection means and/or a holding element at a position spaced from the electrical connection means for holding the light consumable or a mounting unit on which the light consumable is mounted within the housing.

The holding means can include a first holding element of a magnet that engages between a first part of an electrical connection means and a second part of the electrical connection means.

A first part of an electrical connection means can be mounted on or integral within the housing and a second part of the electrical connection means can be mounted on or integral with the light consumable.

The holding means can include a second holding element of a magnet that engages between the housing and the light consumable or a mounting unit on which the light consumable is mounted.

The holding means can releasably hold the light consumable or a mounting unit on which the light consumable is mounted by magnetic force at the opening of the housing so as to retain a light consumable within the housing and ensuring electrical connection at the distal end of the light consumable.

In one form wherein the light consumable is mounted in a mounting unit which includes a circular front plate that complements and fits substantially flush with the opening of the housing and substantially flush with the light emitting front of the light consumable, and the holding means includes a magnetic means releasably holding the rear of the circular front plate of the mounting unit on which the light consumable is mounted by magnetic force to a second magnetic means on an inner part of the housing so as to retain the light consumable within the housing and ensuring electrical connection at the distal end of the light consumable within an inner throat of the housing.

The second holding element of the holding means can be a magnet that engages a metallic ring forming the mounting unit on which the light consumable is mounted.

The holding means can include a magnet that engages with the light consumable.

A particularly preferred form of the invention includes a light consumable housing and changing system having a housing; a removable mounting unit which fits into the housing; a light consumable (globe) that fits into the mounting unit, wherein the housing is broadly conical in shape having an opening at its wider end for allowing the radiation of light from the light consumable and having a throat at the narrower end holding first and second part electrical connection means where the electrical connection is made via abutting engagement; wherein the light consumable is physically held in the removable mounting via a clip-on spring; and wherein the removable mounting unit is held in place in the housing via magnets; the light consumable housing and changing system further including a wand with two heads, one to insert the removable mounting unit and the other to retract the removable mounting unit from the housing from a distant location such as replacing light consumables the floor

The at least one element of the holding means can be positioned on the body of the housing.

The holding means can include a magnet or friction device that engages an electrical connection of the light consumable or the unit on which the light consumable is mounted.

The holding means can releasably hold the light consumable by magnetic or frictional force at the opening or within the housing so as to retain a light consumable or the unit on which the light consumable is mounted within the housing and ensuring electrical connection at the distal end of the light consumable.

The holding means can include a magnet that engages a metallic ring on the light consumable.

The holding means can include a magnet that magnetically engages with the light consumable or a unit on which the light consumable is mounted.

The light consumable changing system can utilise an elongated changing wand for removing and inserting the removable mounting unit from the housing.

The changing wand can include a first removal part or first head located at one end of the changing wand such that when the fitting part or head interacts with the light consumable or the unit on which the light consumable is mounted, the light consumable will be held in place on the first removal part or head.

The first removal part or first head is a magnetic gripping element.

Alternatively, the first removal part or first head is a frictional gripping element.

The first removal part or first head is used to remove the removable mounting unit from the housing.

The first removal part or first head exerts a magnetic or frictional force on the removable mounting unit. That force is greater than the force holding the removable mounting unit in the housing thereby overcoming the housing's holding force thereby allowing the removable mounting unit to be removed.

The changing wand can include a second insertion part or second head located at the opposite end of the wand to the first removal part or first head.

Alternatively the second insertion part or second head can be located on a second wand.

The second insertion part or second head can be a magnetic gripping element.

Alternatively the second insertion part or second head is a frictional gripping element

The second insertion part or second head is used to insert the removable mounting unit into the housing.

The second insertion part or second head exerts a magnetic or frictional force on the removable mounting unit. That force is less than the magnetic or frictional force that the housing exerts. When the second insertion part or second head is brought in contact with the housing the force exerted by the housing overcomes the holding force of the second removal part or second head and self locates the removable mounting unit on which the light consumable is mounted correctly into the housing.

The invention also provides in one form a light consumable housing and changing system including the steps of providing a housing for containing a light consumable including an electrical connection and a holding magnet for engaging a ferromagnetic metallic ring on the light consumable; and providing an elongated changing wand with magnetic gripping heads at each end in a removal head and an opposing insertion head with the magnetic forces exerted by a removal head of the changing wand is greater than the forces exerted by the holding magnet within the housing and with the insertion head of the changing wand exerting magnetic forces lower than the forces exerted by the holding magnet within the housing, wherein in use when the one head is abutted to the ferromagnetic metallic ring the forces exerted by the removal head will be large enough to overcome the forces exerted by the holding magnet within the housing allowing the light consumable to be removed from the housing, and when the insertion head is abutted to the ferromagnetic metallic ring on the light consumable and used to guide the light consumable into the housing the forces exerted by the holding magnet within the housing on the ferromagnetic metallic ring will be large enough to release the light consumable from the insertion head and hold it within the housing.

It can be seen that the invention includes a housing with a magnetic element as a holding means for releasably securing a light consumable and a removal wand for interacting with the light consumable to provide a light consumable changing system that can remove or insert a light consumable into the housing. The wand includes a pair of fitting parts, one for removal of the light consumable from the housing and one for inserting the light consumable into the housing where both fitting means exert a force, either magnetic or frictional, on the light consumable.

A further major advantage of the system is that it can be adapted to use standard known light consumables without any modifications by use of mounting units and different housings. In this way the globe industry need not be affected.

However on the alternative side if modified light consumables are created for other reasons such can be incorporated in the housing of the present invention by use off the mounting unit.

The invention also provides a light consumable housing and changing system which can include the steps of:
a) providing a housing for use in a light consumable changing system including at least one opening for receiving the light consumable or the mounting unit on which the light consumable is mounted, and a first part of an electrical connection means at one end of the housing;
b) providing a light consumable or the unit on which the light consumable is mounted and mounting a second part of the electrical connection means on the light consumable;
c) providing a holding means for releasably holding the light consumable wherein at least one element of the holding means is magnetic;
d) providing a changing wand with a first removal part and a second insertion part located at opposing ends of the wand and;
e) interacting the first fitting end of the wand with a light consumable to remove the light consumable from the housing by overcoming the magnetic forces provided by the housing means.

A light consumable housing and changing system of the invention can include the steps of:
a) providing a housing for use in a light consumable changing system including at least one opening for receiving the light consumable or the mounting unit on which the light consumable is mounted, an electrical connection means at one end and a holding means for releasably holding the light consumable;
b) providing a changing wand with a first removal part and a second insertion part located at opposing ends of the wand; and
c) interacting the second insertion part of the wand with a light consumable to insert the light consumable into the housing through the opening such that insertion is achieved by the magnetic forces of the housing overpowering the magnetic forces provided by the second insertion part of the wand.

### BRIEF DESCRIPTION OF THE DRAWINGS

In order that the invention can be more readily understood embodiments will be described by way of non-limiting example with reference to the drawings wherein: FIG. 1 is a perspective view of a first embodiment of an apparatus for use in a light consumable changing system according to the invention the apparatus including a housing for a light consumable;

FIG. 2 is a perspective view of a second embodiment of an apparatus for use in a light consumable changing system according to the invention the apparatus including a housing having spring mounts for mounting the housing in a roof cavity or the like;

FIG. 3 is a diagrammatic view of the second embodiment of an apparatus of FIG. 2 including a housing and a removable mounting unit with the light consumable and electrical connector affixed;

FIG. 4 is a perspective view of an electrical connection means for use in the first and second embodiments of an apparatus for use in a light consumable changing system according to the invention the electrical connection means including a first part and a second part;

FIG. 5 is a plan underneath view of the first and second embodiments of an apparatus for use in a light consumable changing system according to the invention the apparatus including a housing ring, a metallic ring being part of the removable mounting unit and a light transmission opening of a light consumable;

FIG. 6 is a diagrammatic view of a changing wand for use in the first or second embodiment of an apparatus for use in a light consumable changing system according to the invention;

FIG. 7 is a side view of the first embodiment of an apparatus for use in a light consumable changing system according to the invention the apparatus for use in a light consumable changing system according to the invention the apparatus including a housing and a removable mounting unit upon which a light consumable is mounted;

FIG. 8 is a cross sectional view along B-B of the apparatus of FIG. 7;

FIG. 9 is a side view of the second embodiment of an apparatus for use in a light consumable changing system according to the invention the apparatus for use in a light consumable changing system according to the invention the apparatus including a housing and a removable mounting unit upon which a light consumable is mounted;

FIG. 10 is a side view of the apparatus of FIG. 9 rotated 90° around vertical axis;

FIG. 11 is a diagrammatic cross sectional view along A-A of the apparatus of FIG. 9 of the housing of the apparatus for use in the second embodiment without the light consumable;

FIG. 12 is a cross sectional view along A-A of the removable mounting unit upon which a light consumable is mounted within the apparatus of FIG. 9; and

FIG. 13 is a diagrammatic cross sectional view along A-A of the apparatus of FIG. 9 of the housing and the light consumable of the apparatus for use in the second embodiment.

### DESCRIPTION OF PREFERRED EMBODIMENTS OF THE INVENTION

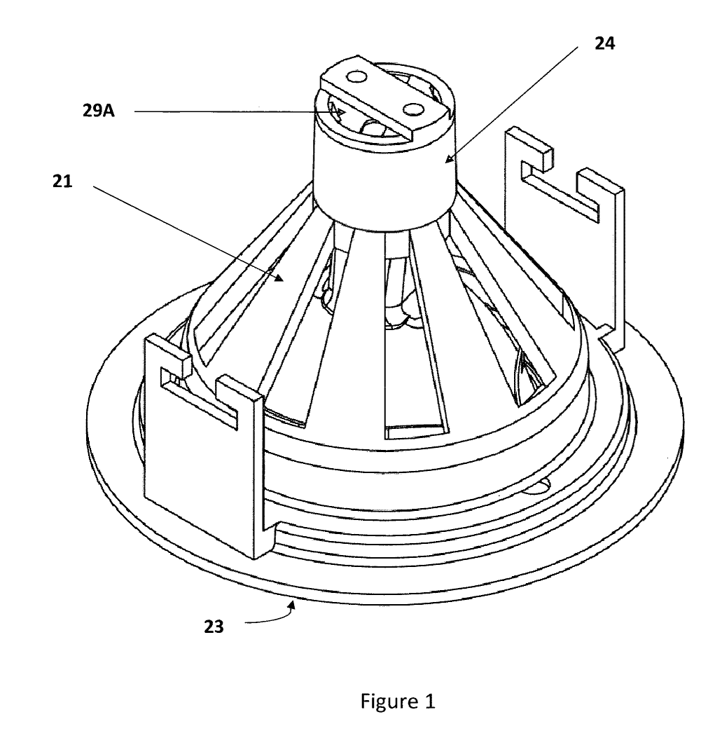

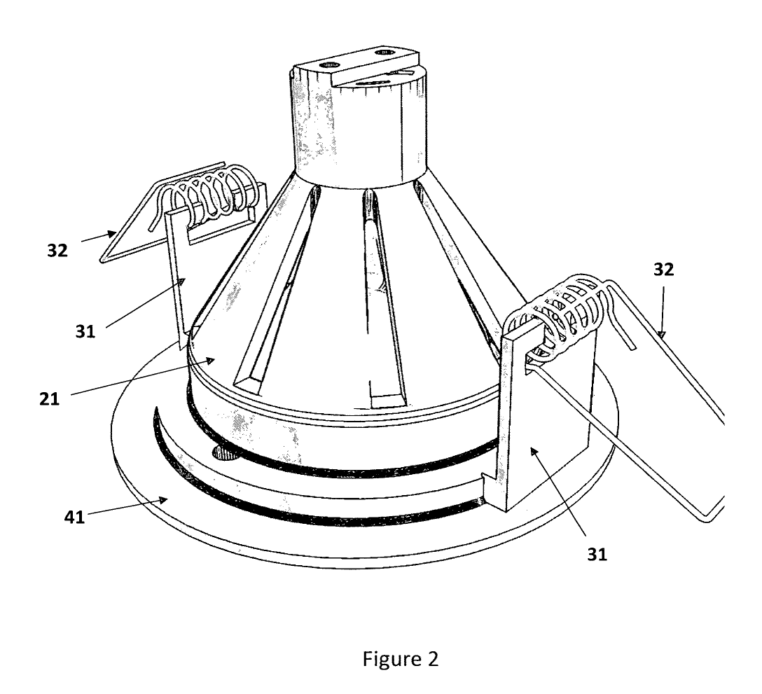

Referring to the drawings there is shown particularly in FIGS. 1 to 3 and 5, a housing for use in a light consumable housing and changing system of the invention. The housing 21 including a broadly conical shaped body formed by walls having slit openings extending along its length to provide cooling channels for the light consumable mounted therein. The housing 21 having an opening 23 at the largest end for allowing radiation of light from the mounted light consumable, and a throat 24 at the opposing narrow end for holding or integrally having one part 29A of an electrical connection means. The throat 24 at an end opposite the opening 23 is sized smaller to receive the second part 29B of the electrical connection means of the mounted light consumable and providing electrical connection to the at least one part of the electrical connection means by abutting engagement. This will be further described later.

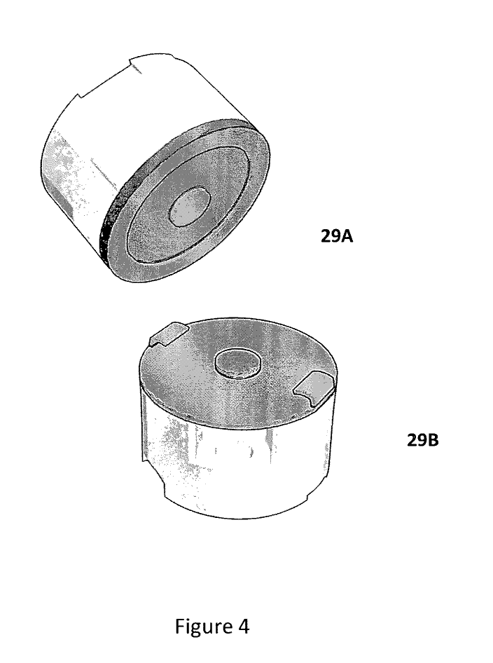

The outer side of the broadly conically shaped body of the housing 21 includes two diametrically located housing uprights 31 extending from the back of a housing ring 41 at the outer edges of the housing. Attached to the diametrically located housing uprights 31 are spring mounts 32 for resiliently engaging supporting elements in a wall or roof cavity such that only the front of the base of the broadly conical shaped body of the housing 21 is seen giving the visual look of FIG. 5 with an outer ring being the outer front of the housing ring 41, a annular smaller metallic ring being part of the removable mounting unit upon which a light consumable is mounted 42 and a light transmission opening 43 either open or covered by a glass plate providing the opening 23 for transmission of light from the mounted light consumable 22 in the housing 21.

It can therefore be seen that the light consumable changing system includes the fundamental elements of a housing 21 for holding a light consumable 22 or a mounting unit 42 on which the light consumable 22 is mounted. The housing includes at least one opening 23 for receiving the light consumable 22 and allowing transmission of light from the light consumable when mounted in the housing 21. An electrical connection means having first and second parts 29A and 29B provide the electric power to the mounted light consumable.

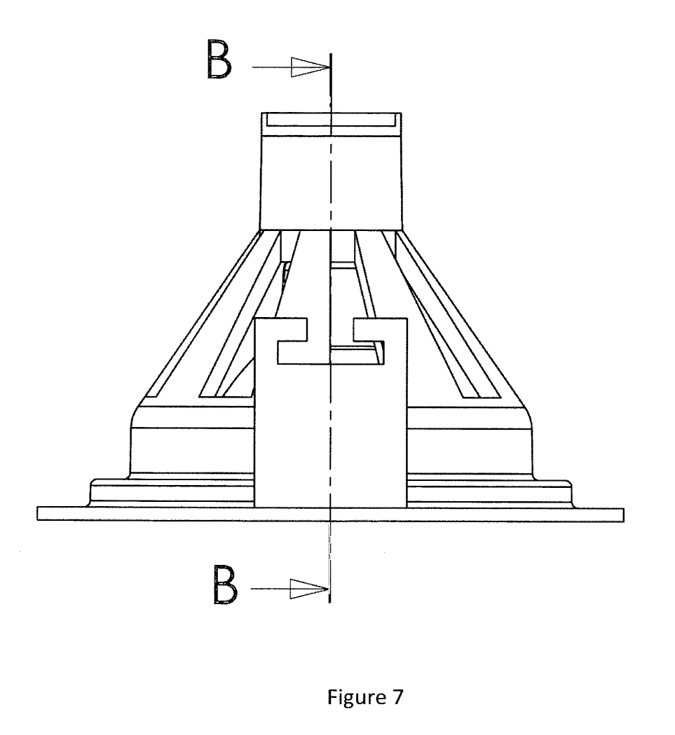

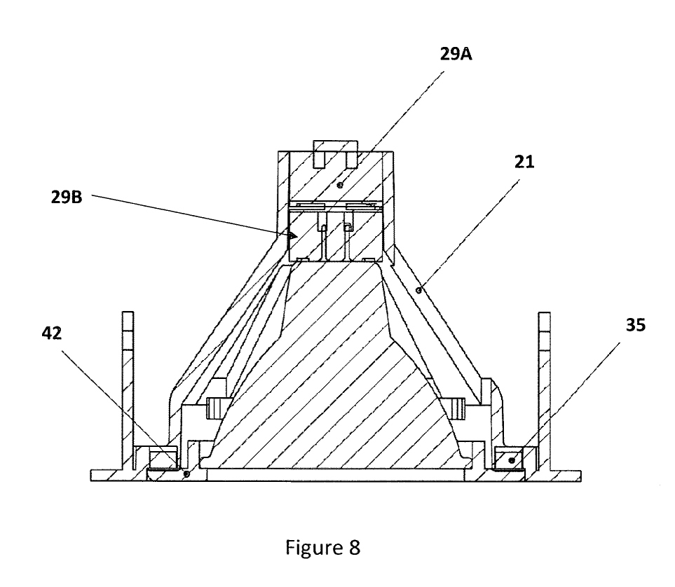

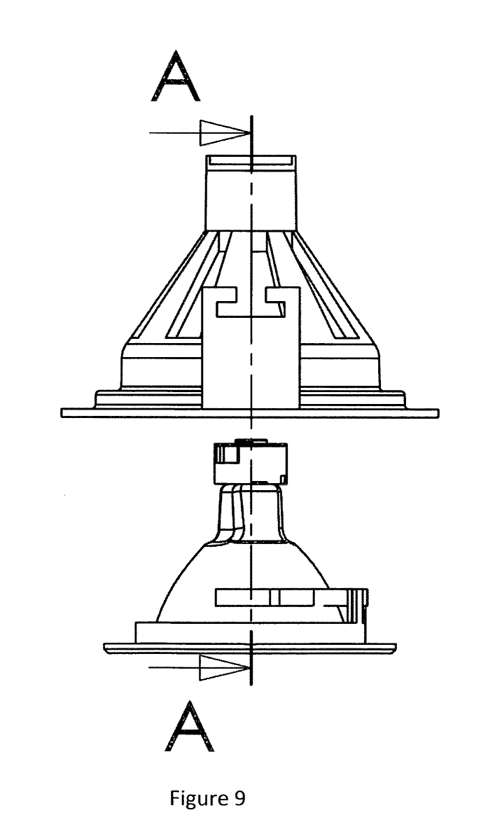

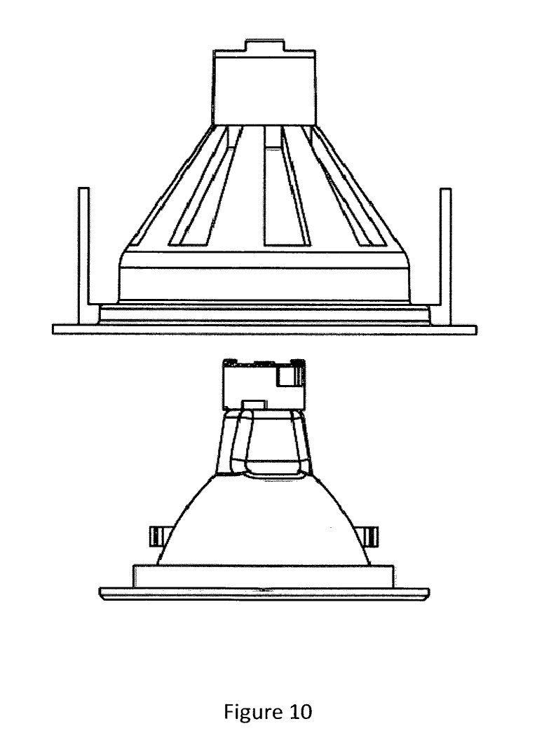

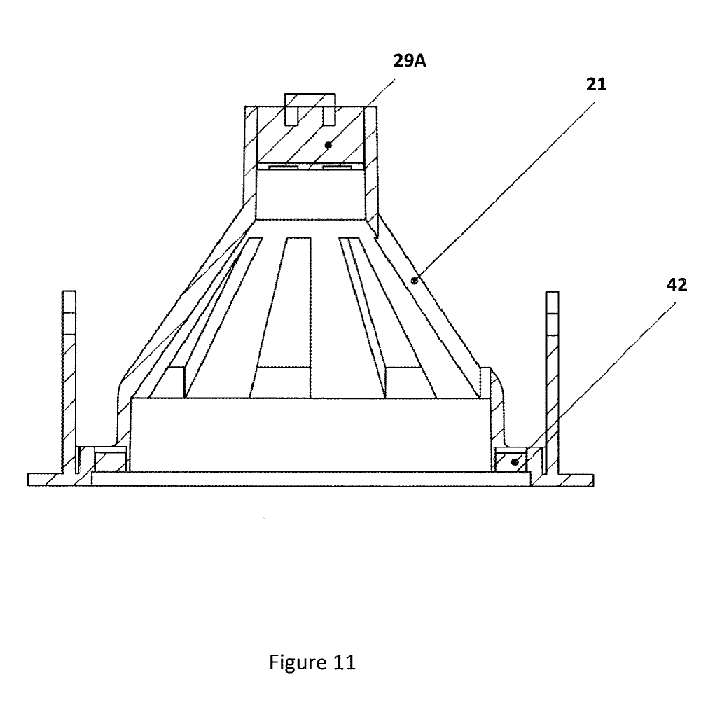

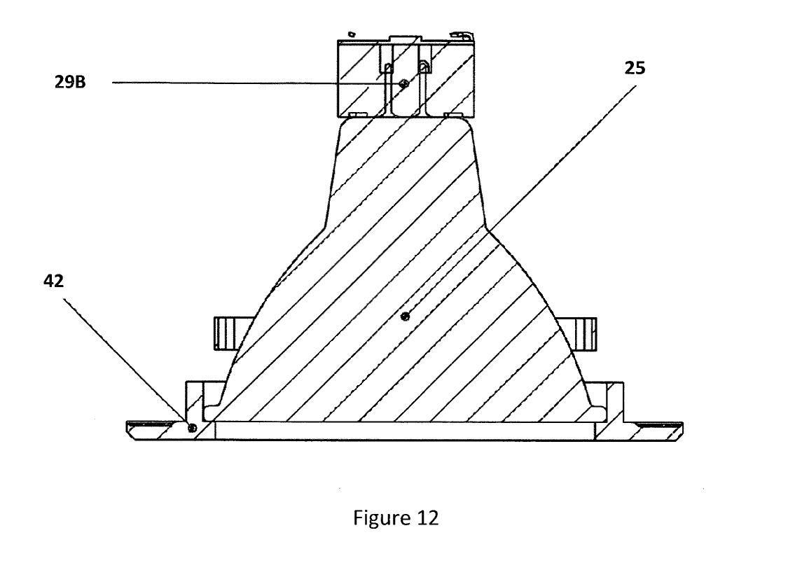

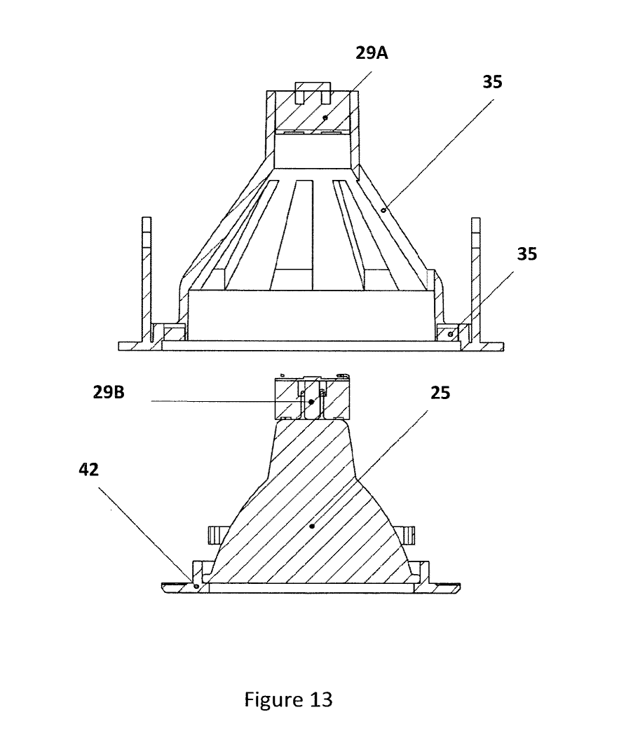

Referring to FIGS. 7 to 13 in order to retain the light consumable 22 or a mounting unit on which the light consumable is mounted there is a holding means 35 for releasably holding the light consumable or removable mounting unit by at least one magnetic element. The holding means 35 includes a holding element of a magnet that engages between the housing 21 and the light consumable 22 or as shown in FIG. 8 a mounting unit being a metallic ring 42 on which the light consumable 22 is mounted. The shaping of the internal throat 24 of the housing and the first and second parts of the electrical connection means 29A and 29B result in the holding means aligning and ensuring electrical connection by abutment between the first part of an electrical connection means 29A and a second part of the electrical connection means 29B.

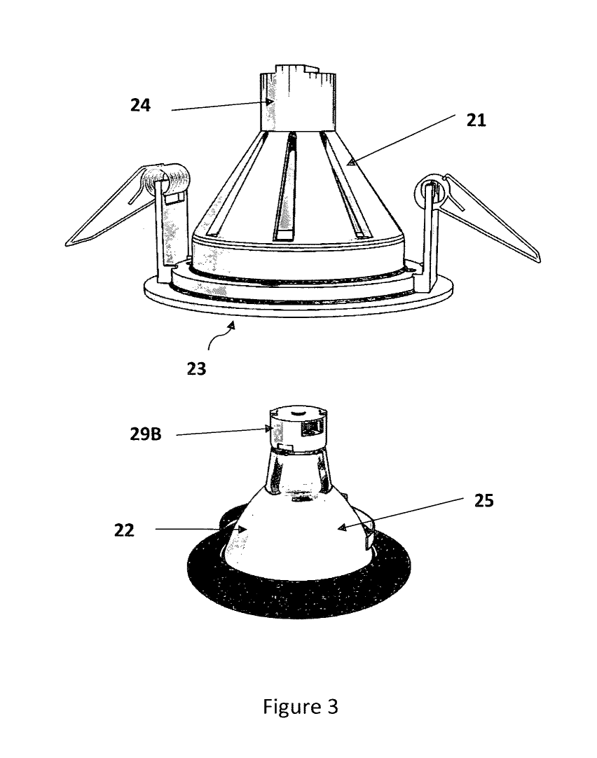

To ensure electrical contact the connections of the first part of the electrical connection means 29A and the second part of the electrical connection means 29B can be complementary or as shown in FIG. 4 can be two Vosssloh Schwabe ceramic connectors with one having a central contact and an outer annular contact and the other having a matching central contact and two diametrically opposed contacts thereby providing connection regardless of the relative rotational orientation of the mounting of the light consumable 25 within the housing 21.

The holding means is in the form of a magnetic element 35 that will result in attraction between it and the ferromagnetic material of the ring forming part of the removable mounting unit upon which a light consumable is mounted 42. For the purposes of 12 volt down light fittings this includes light consumables that include a light emitting source of a globe 25 having an integral reflecting cone front glass pane and outer front flange, a part of an electrical connection that fits into part 29B at one end of the reflecting cone and a part of the removable mounting unit being a metallic holding ring 42 that engages and frictionally holds the outer front flange of the globe 25.

The invention not merely provides a novel housing but more particularly provides a light consumable housing and changing system. This includes providing a housing, a removable mounting unit upon which a light consumable is mounted as well as an electrical connection and a holding magnet for engaging the removable mounting unit. However it also includes providing an elongated changing wand 51 with magnetic gripping heads 52 at each end of an elongated pole 53. The magnetic gripping heads 52 including a removal head and an opposing insertion head.

The magnetic gripping heads 52 have magnetic elements 54 located in ring arrangement corresponding to the size of the metallic removable mounting unit 42 on which the light consumable 22 is mounted.

Also the magnetic elements of the holding means 35 are sized and mounted on the inner side of the housing within the diametrical dimensions of the metallic removable mounting unit 42 on which the light consumable 22 is mounted so as to magnetically retain the removal mounting unit 42 and thereby the light consumable within the housing 21.

The differences of the magnetic forces exerted by the magnetic gripping heads 52 at each end of the changing wand and the magnetic force exerted by the magnetic connection of the holding means 35 to the removable mounting unit 42 is important in order to provide a system that is useable from a distance.

In particular the magnetic force exerted by the magnetic connection of the removal head of the changing wand 51 is greater than the forces exerted by the holding means 35 magnet within the housing 21 and with the insertion head of the changing wand 51 exerting magnetic forces lower than the forces exerted by the holding means magnet within the housing.

Therefore in use when the one head is abutted to removable mounting unit 42 the forces exerted by the removal head of the changing wand 51 will be large enough to overcome the forces exerted by the holding means magnet within the housing allowing the removable mounting unit upon which the light consumable is mounted 22 to be removed from the housing 21. Similarly when the insertion head is abutted to the removable mounting unit 42 and used to guide the light consumable 22 into the housing 21 the forces exerted by the holding means 35 magnet within the housing 21 on the removable mounting unit 42 will be large enough to release the removable mounting unit upon which a light consumable is mounted from the insertion head of the changing wand 51 and hold it within the housing 21. The holding means can thereby releasably hold the removable mounting unit upon which a light consumable is mounted by magnetic force at the opening of the housing so as to retain a light consumable within the housing and ensuring electrical connection at the distal end of the light consumable.

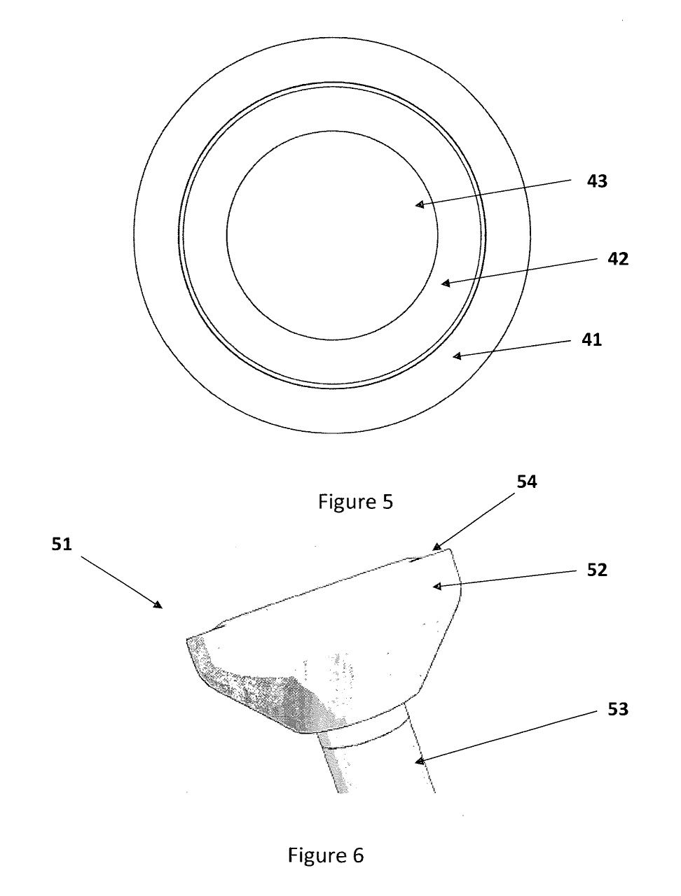

Referring to FIGS. 5 and 6, the changing wand 51 includes two heads 52 that are located at each end of the wand. Alternatively two separate wands can be used with one head located on each. Each head contains magnetic material to which the unit is attracted. The force each head exerts is different.

The head of one wand would exert a magnetic force greater than the magnetic force used to hold the unit holding the light consumable in the housing. When the first head is brought in contact with the unit its magnetic force overcomes the magnetic force holding the unit in the housing and the unit attaches itself to the first head. The first head is then lowered to the ground where the light consumable is physically replaced.

The head of the second wand would exert a magnetic force less than the magnetic force used to hold the unit holding the light consumable in the housing, the unit (with a working light consumable inserted) is attached and held on the second head by the magnetic force of the second head. As the unit is brought in contact with the housing the magnetic force of the housing overcomes the magnetic force holding the unit on the second head this completing the light consumable changing process.

The changing wands 51 should be of sufficient length to reach the light housing that is located on the ceiling. If the light housing cannot be reached with the wand, the wand could telescope to increase its length.

Therefore in use a light consumable changing system of the invention uses a housing including at least one opening for receiving the light consumable, an electrical connection means at one end and a holding means for releasably holding a removable mounting unit upon which a light consumable is mounted. The system then uses a changing wand with a first removal part and a second insertion part located at opposing ends of the wand and by interacting the first fitting end of the wand with a removable mounting unit upon which a light consumable is mounted light to remove the light consumable from the housing by overcoming the magnetic forces provided by the housing means.

Similarly in reverse there is interacting of the second insertion part of the wand with a removable mounting unit upon which a light consumable is mounted to insert the light consumable into the housing through the opening such that the by the magnetic forces of the housing overpowering the magnetic forces provided by the second insertion part of the wand.

While we have described herein a particular embodiment of a light consumable housing and changing system, it is further envisaged that other embodiments of the invention could exhibit any number and combination of any one of the features previously described. However, it is to be understood that any variations and modifications that would be readily understood by a person skilled in the art and made without departing from the spirit of the invention and without any inventiveness are included within the scope of this invention.

For example other embodiments can include substituting magnetic elements with frictional elements. Any one or more of the three magnetic elements, namely the magnetic holding element for securing the unit holding the light consumable in the housing, the first head and the second head of the changing wand can be substituted with a frictional element. The critical factor being the force holding the unit holding the light consumable within the housing must be less than the force exerted by the first head and greater than the force exerted by the second head. Moore particularly by the use of a magnetic connection the use of frictional force only needs to break the magnetic holding force and not require two handed simultaneous manoeuvres to release and change the light consumable.

There are many options for the elements while maintaining the benefit of at least one element being a magnetic hold. This can be combined with frictional elements that then use other mechanisms in combination with the magnetic element including a twist locking means or gripping claws are some examples.

Substituting magnetic elements can result in the following combinations:
a) Magnetic insertion fitting part and Magnetic removal fitting part and Magnetic holding element within the housing;
b) Magnetic insertion fitting part and Magnetic removal fitting part and Frictional holding element within the housing;
c) Magnetic insertion fitting part and Frictional removal fitting part and Magnetic holding element within the housing;
d) Magnetic insertion fitting part and Frictional removal fitting part and Frictional holding element within the housing;
e) Frictional insertion fitting part and Magnetic removal fitting part and Magnetic holding element within the housing;
f) Frictional insertion fitting part and Magnetic removal fitting part and Frictional holding element within the housing; and
g) Frictional insertion fitting part and Frictional removal fitting part and Magnetic holding element within the housing.

Further alternative embodiments could include substituting the need for two magnetic heads of differing magnetic strengths with a wand with one head that has a device that can vary the magnetic strength of the head. Another embodiment could include having each head located on a separate wand rather than having a head at each end of one wand.

These and other variations are including within the scope of this invention as defined in the following claims.

1-36. (canceled)

37. A light consumable housing apparatus including:
a. a light consumable or a mounting unit on which a light consumable is mounted;
b. a housing having at least one opening for receiving the light consumable or the mounting unit and the light consumable mounted thereon;
c. an electrical connection means for connection of the light consumable to an electricity supply when mounted in the housing;
d. a holding means for releasably holding the light consumable or the mounting unit on which the light consumable is mounted to the housing;
wherein at least one element of the holding means is magnetic.

38. A light consumable housing apparatus according to claim 37 wherein the housing includes a body with a concave shape leading from an inner throat to a larger light emitting opening.

39. A light consumable housing apparatus according to claim 38 wherein the electrical connection means has a first part of the electrical connection on the mounted light consumable and forming an electrical connection by abutting engagement to a second part of the electrical connection mounted in the throat of the housing.

40. A light consumable housing apparatus according to claim 37 wherein the housing includes a spring means for releasably mounting the housing in a ceiling cavity.

41. A light consumable housing apparatus according to claim 37 wherein the holding means includes a first part of a magnetic means whereby a second part of the magnetic means mounted on an elongated arm can be positioned adjacent the first part of the magnetic means and provide magnetic force at the opening so as to withdraw the light consumable or the unit on which the light consumable is mounted from within the housing.

42. A light consumable housing apparatus according to claim 37 wherein the holding means includes at least one element positioned on the inside body of the housing for releasably holding, at least partly by magnetic force, the light consumable or the mounting unit on which the light consumable is mounted within the housing.

43. A light consumable housing apparatus according to claim 37 wherein the holding means includes a holding element at the electrical connection means and/or a holding element at a position spaced from the electrical connection means for holding the light consumable or a mounting unit on which the light consumable is mounted within the housing.

44. A light consumable housing apparatus according to claim 43 wherein the holding element comprises a first holding element of a magnet that engages between a first part of an electrical connection means and a second part of the electrical connection means.

45. A light consumable housing apparatus according to claim 37 wherein a first part of an electrical connection means is mounted on or is integral within the housing and a second part of the electrical connection means is mounted on or is integral with the light consumable.

46. A light consumable housing apparatus according to any one of the preceding claims wherein the light consumable is mounted in a mounting unit which includes a circular front plate that complements and fits substantially flush with the opening of the housing and substantially flush with the light emitting front of the light consumable, and the holding means includes a magnetic means releasably holding the rear of the circular front plate of the mounting unit on which the light consumable is mounted by magnetic force to a second magnetic means on an inner part of the housing so as to retain the light consumable within the housing and ensuring electrical connection at the distal end of the light consumable within an inner throat of the housing.

47. A light consumable housing apparatus according to claim 46 wherein a second part of the holding means is a magnet that engages a metallic ring fixed to the rear of the circular front plate of the mounting unit on which the light consumable is mounted.

48. A light consumable housing apparatus according to claim 37 wherein the holding means includes a magnet that engages with the light consumable.

49. A light consumable housing apparatus according to claim 37, wherein the light consumable housing apparatus comprises of a changing system including the steps of:
e. providing a housing for containing a light consumable including an electrical connection and a holding magnet for engaging a ferromagnetic metallic ring on the light consumable; and
f. providing an elongated changing wand with magnetic gripping heads at each end in a removal head and an opposing insertion head with the magnetic forces exerted by a removal head of the changing wand is greater than the forces exerted by the holding magnet within the housing and with the insertion head of the changing wand exerting magnetic forces lower than the forces exerted by the holding magnet within the housing,
g. wherein in use when the one head is abutted to the ferromagnetic metallic ring the forces exerted by the removal head will be large enough to overcome the forces exerted by the holding magnet within the housing allowing the light consumable to be removed from the housing, and when the insertion head is abutted to the ferromagnetic metallic ring on the light consumable and used to guide the light consumable into the housing the forces exerted by the holding magnet within the housing on the ferromagnetic metallic ring will be large enough to release the light consumable from the insertion head and hold it within the housing.

50. A light consumable housing apparatus according to claim 49, wherein the changing system includes the removal steps of:
h. providing a housing for use in a light consumable changing system including at least one opening for receiving the light consumable or the mounting unit on which the light consumable is mounted, and a first part of an electrical connection means at one end of the housing;
i. providing a light consumable or the unit on which the light consumable is mounted and mounting a second part of the electrical connection means on the light consumable;
j. providing a holding means for releasably holding the light consumable wherein at least one element of the holding means is magnetic;
k. providing a changing wand with a first removal part and a second insertion part located at opposing ends of the wand and;
l. interacting the first fitting end of the wand with a light consumable to remove the light consumable from the housing by overcoming the magnetic forces provided by the housing means.

51. A light consumable housing according to claim 50 wherein the changing wand can include a first removal part or first head located at one end of the changing wand such that when the fitting part or head interacts with the light consumable or the unit on which the light consumable is mounted, the light consumable will be held in place on the first removal part or head.

52. A light consumable housing according to claim 50 wherein the changing wand has a second insertion part or second head to exert a magnetic or frictional force on the removable mounting unit with that force being less than the magnetic or frictional force that the housing exerts and when the second insertion part or second head is brought in contact with the housing the force exerted by the housing overcomes the holding force of the second removal part or second head and self locates the removable mounting unit on which the light consumable is mounted correctly into the housing.

53. A light consumable housing apparatus according to claim 37 wherein the light consumable housing apparatus, for receiving a light consumable or a mounting unit on which a light consumable is mounted, the includes:
m. a housing including a body with a concave shape leading from an inner throat to a larger light emitting opening forming an opening for receiving the light consumable or the mounting unit on which a light consumable is mounted thereon;
n. an electrical connection means for connection of the light consumable to an electricity supply when mounted in the housing and having a first part on the mounted light consumable or a mounting unit on which a light consumable is mounted and forming an electrical connection by abutting engagement to a second part of the electrical connection mounted in the throat of the housing;
o. a holding means including a magnetic means releasably holding a rear portion of the light consumable or the mounting unit on which the light consumable is mounted to an inner part of the housing so as to retain the light consumable within the housing and ensuring electrical connection at the distal end of the light consumable within the inner throat of the housing; and wherein the holding means includes a circular front metallic plate that complements and fits substantially flush with the opening of the housing and substantially around and flush with the light emitting front of the light consumable housing and wherein magnetic means engaging with the circular front metallic plate allows for ready overcoming of the holding means and removal of the light consumable or the mounting unit on which the light consumable is mounted from the housing.

54. A light consumable housing apparatus according to claim 53 wherein the holding means holding the rear of the light consumable or the mounting unit on which the light consumable is mounted to an inner part of the housing includes a magnetic means; whereby a magnetic means mounted on an elongated arm can be positioned adjacent the circular front metallic plate and provide magnetic force at the opening greater than magnetic force of the holding means so as to withdraw the light consumable or the unit on which the light consumable is mounted from within the housing.

55. A light consumable housing apparatus according to claim 54 wherein the holding means includes a magnet fixed to the rear of the circular front plate of the mounting unit on which the light consumable is mounted.

56. A light consumable housing apparatus according to claim 54 wherein the elongated arm includes an insertion part or head which exerts a magnetic or frictional force on the removable mounting unit sufficient to hold it on the end of the elongated arm with that force being less than the magnetic or frictional force that the housing exerts and overcomes the holding force of the insertion part or head and self locates the removable mounting unit on which the light consumable is mounted correctly into the housing.
